(19) United States
(12) Patent Application Publication
(10) Pub. No.: US 2011/0078678 A1
(43) Pub. Date: Mar. 31, 2011

(54) METHODS AND APPARATUS FOR PRODUCING CROSS-PLATFORM SOFTWARE APPLICATIONS

(75) Inventor: Joshua Scott Matthews, Baltimore, MD (US)

(73) Assignee: OPEN KERNEL LABS, Chicago, IL (US)

(21) Appl. No.: 12/570,896

(22) Filed: Sep. 30, 2009

(51) Int. Cl. G06F 9/445

(52) U.S. Cl. 717/178; 717/174

(57) ABSTRACT

The present disclosure provides a system that produces cross-platform software applications by installing different container applications on different hardware platforms. Each container application is native to that hardware platform and includes a web browser and a web server. Standard web applications run locally on the hardware platform due to the local web server, and the standard web applications appear native to each different hardware platform because a converter in the container application converts standard web browser controls to native appearing controls.

### TECHNICAL FIELD

The present application relates in general to software and more specifically to methods and apparatus for producing cross-platform software applications.

### BACKGROUND

Typically, software developers, especially mobile application developers, must modify their code to take advantage of the different look and feel aspects of different hardware platforms. For example, controls such as input boxes, buttons, etc. look and potentially operate differently on different smart phones. In addition, developers may need to use an application development framework that is native to each device, and those frameworks are typically incompatible. For example, an application that needs to be deployed on both an iPhone and an Android phone needs to be re-written. Maintaining multiple version of the same software application is burdensome and costly

### SUMMARY

The presently disclosed system solves this problem by installing different container applications on different hardware platforms. Each container application is native to that hardware platform and includes a web browser and a web server. Standard web applications run locally on the hardware platform due to the local web server, and the standard web applications appear native to each different hardware platform because a converter in the container application converts standard web browser controls to native appearing controls.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a process for producing cross-platform software applications.

FIG. 4 is a block diagram showing different hardware platforms with associated container applications.

### DETAILED DESCRIPTION

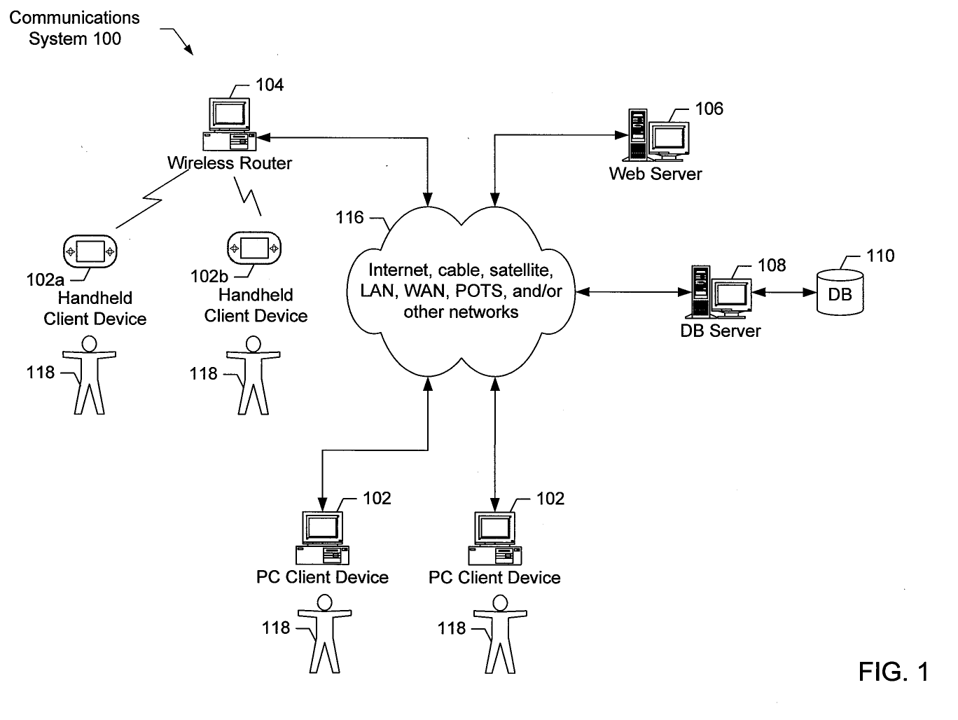

The disclosed system is most readily realized in a network communications system. A high level block diagram of an exemplary network communications system 100 is illustrated in FIG. 1. The illustrated system 100 includes one or more client devices 102, one or more wireless routers 104, one or more web servers 106, and one or more database servers 108 connected to one or more databases 110. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

In an example mode of operation, users 118 of the system 100 consume one or more web pages received from the web server 106. The web pages may be any suitable type of web page such as search engine results. The web pages preferably include advertising content and non-advertising content.

One web server 106 may interact with a large number of client devices 102. Accordingly, each web server 106 is typically a high end computing device with a large storage capacity, one or more fast microprocessors, and one or more high speed network connections. Conversely, relative to a typical web server 106, each client device 102 typically includes less storage capacity, less processing power, and a slower network connection.

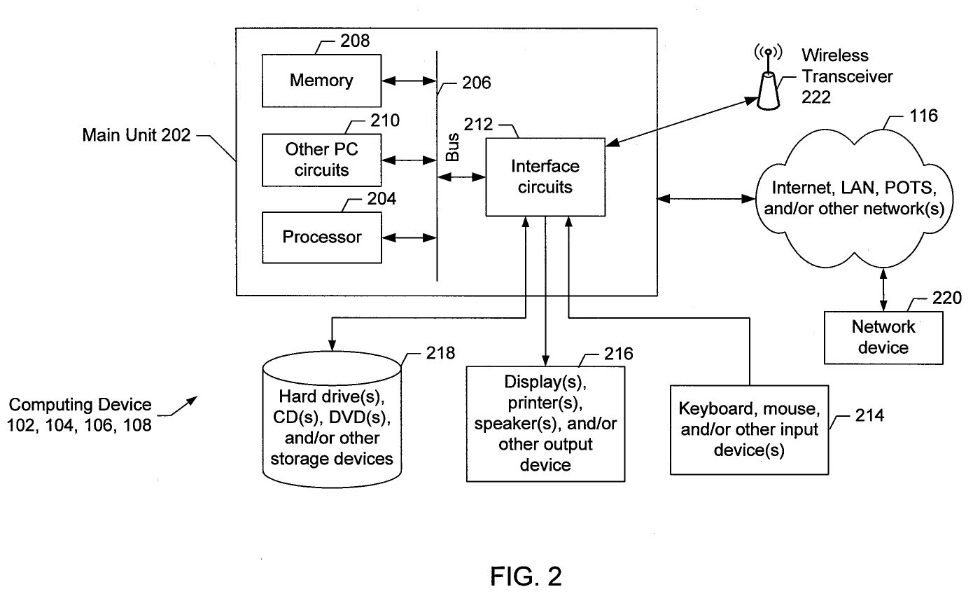

A detailed block diagram of an example computing device 102, 104, 106, 108 is illustrated in FIG. 2. Each computing device 102, 104, 106, 108 may include a server, a personal computer (PC), a personal digital assistant (PDA), a portable audio player, a portable audio/video player, a mobile telephone, and/or any other suitable computing device. Each computing device 102, 104, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions that interact with the other devices in the system 100 as described herein. These software instructions may be executed by the processor 204 in any suitable manner. The memory 208 and/or another storage device 218 may also store one or more data structures, digital data indicative of documents, files, programs, web pages, etc. retrieved from another computing device 102, 104, 106, 108 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the computing device 102, 104, 106, 108. For example, the display 216 may be used to display web pages received from the web server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 104, 106, 108.

Each computing device 102, 104, 106, 108 may also exchange data with other computing devices 102, 104, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users of the system 100 may be required to register with the web server 106. In such an instance, each user may choose a user identifier (e.g., e-mail address) and a password which may be required for the activation of services. The user identifier and password may be passed across the communication channel(s) 116 using encryption built into the user's browser, software application, or device. Alternatively, the user identifier and/or password may be assigned by the web server 106.

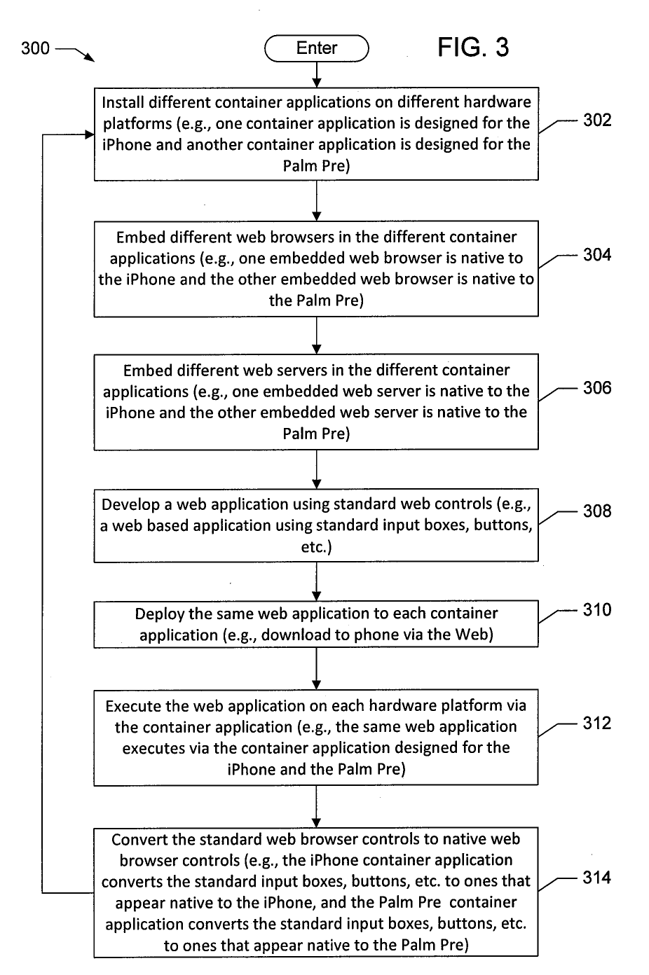

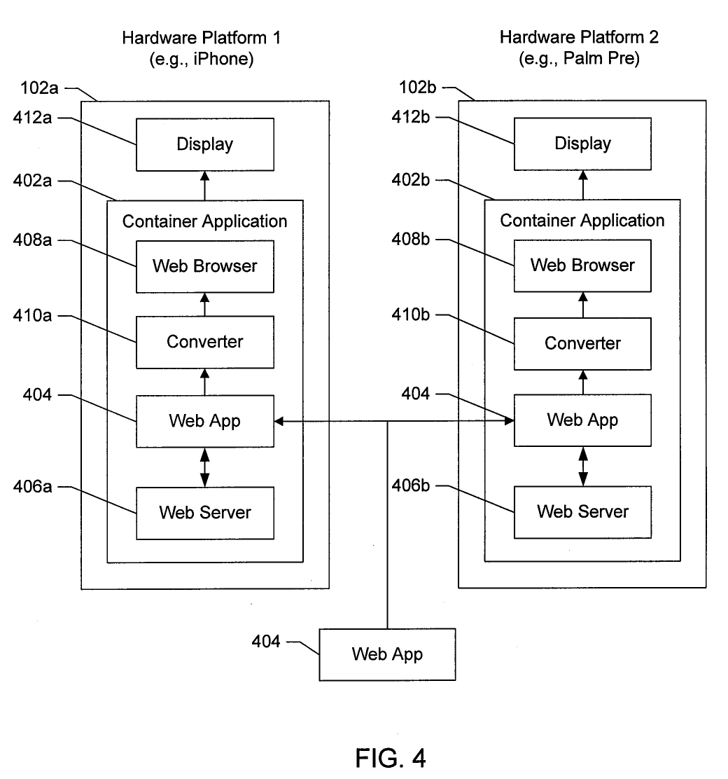

A flowchart of an example process 300 for producing cross-platform software applications is presented in FIG. 3. A block diagram showing different hardware platforms 102 is presented in FIG. 4. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and some of the steps described may be optional.

In general, different container applications 402 are installed on different hardware platforms 102. Each container application 402 is native to that hardware platform 102 and includes a web browser 408 and a web server 410. Standard web applications 404 run locally on the hardware platform 102 due to the local web server 406, and the standard web applications 404 appear native to each different hardware platform 102 because a converter 410 in the container application 402 converts standard web browser controls to native appearing controls.

The process 300 begins by installing different container applications 402 on different hardware platforms 102 (block 302). For example, one container application 402 may be designed for the iPhone, and another container application 402 may be designed for the Palm Pre. Alternatively, the developer could utilize a build system that bundles the container application with an associated web application in a package that appears native to the final platform. Each container application 402 includes an embedded web browser 408 that is native to that hardware platform 102 (block 304). For example, one embedded web browser 408 may be native to the iPhone, and the other embedded web browser 408 may be native to the Palm Pre. Each container application 402 also includes an embedded web server 406 that is native to that hardware platform 102 (block 306). For example, one embedded web server 406 may be native to the iPhone, and the other embedded web server 406 may be native to the Palm Pre.

Software developers may then develop web applications 404 using standard web controls (block 308). For example, software developers may develop a web based application 404 using standard input boxes, buttons, etc. The same web application 404 may then be deployed to each container application 402 (block 310). For example, users may download the web application 404 to their phones via the Web. Each web application 404 may then be executed on each hardware platform 102 via the container application 402 (block 312). For example, the same web application 404 may be executed via the container application 402 designed for the iPhone and the Palm Pre.

When the web application 404 is being executed, a converter 410 in the container application 402 converts the standard web browser controls to native web browser controls (block 314). For example, the iPhone container application 402 converts the standard input boxes, buttons, etc. to ones that appear native to the iPhone, and the Palm Pre container application 402 converts the standard input boxes, buttons, etc. to ones that appear native to the Palm Pre. The container application may also provide controls that allow access to devices on the final platform. For example, a framebuffer device control may be provided, which would allow the developer to directly draw output on the screen of the device.

In summary, persons of ordinary skill in the art will readily appreciate that methods and apparatus for producing cross-platform software applications have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of producing cross-platform software applications, the method comprising:
installing a first container application on a first hardware platform, the first container application embedding a first web browser associated with the first hardware platform, the first container application embedding a first web server associated with the first hardware platform, the first container application converting a plurality of standard web browser controls to appear as first native application controls associated with the first hardware platform;
installing a second different container application on a second different hardware platform, the second container application embedding a second web browser associated with the second hardware platform, the second container application embedding a second web server associated with the second hardware platform, the second container application converting the plurality of standard web browser controls to appear as second different native application controls associated with the second hardware platform;
deploying a web application to both the first container application on the first hardware platform and the second container application on the second hardware platform;
executing the web application via the first container application to produce a first display that appears native to the first hardware platform; and
executing the web application via the second container application to produce a second different display that appears native to the second hardware platform.

2. The method of claim 1, wherein installing the first container application on the first hardware platform includes installing the first container application via a download form a global network.

3. The method of claim 1, wherein deploying the web application to the first container application on the first hardware platform includes deploying the web application via a download form a global network.

4. The method of claim 1, wherein installing the first container application and deploying the web application include transmitting a build system that bundles the container application with the web application in a package that appears native to the final platform.

5. The method of claim 1, wherein the first container application provides controls that allow access to hardware devices on the first hardware platform.

6. An apparatus for cross-platform software applications, the apparatus comprising:
a processor;
an input device operatively coupled to the processor;
an output device operatively coupled to the processor; and
a memory device operatively coupled to the processor, the memory device storing instructions to cause the processor to:
install a first container application on a first hardware platform, the first container application embedding a first web browser associated with the first hardware platform, the first container application embedding a first web server associated with the first hardware platform, the first container application converting a plurality of standard web browser controls to appear as first native application controls associated with the first hardware platform;
install a second different container application on a second different hardware platform, the second container application embedding a second web browser associated with the second hardware platform, the second container application embedding a second web server associated with the second hardware platform, the second container application converting the plurality of standard web browser controls to appear as second different native application controls associated with the second hardware platform;
deploy a web application to both the first container application on the first hardware platform and the second container application on the second hardware platform;
execute the web application via the first container application to produce a first display that appears native to the first hardware platform; and
execute the web application via the second container application to produce a second different display that appears native to the second hardware platform.

7. The apparatus of claim 6, wherein installing the first container application on the first hardware platform includes installing the first container application via a download form a global network.

8. The apparatus of claim 6, wherein deploying the web application to the first container application on the first hardware platform includes deploying the web application via a download form a global network.

9. The apparatus of claim 6, wherein installing the first container application and deploying the web application include transmitting a build system that bundles the container application with the web application in a package that appears native to the final platform.

10. The apparatus of claim 6, wherein the first container application provides controls that allow access to hardware devices on the first hardware platform.

11. A computer readable memory device storing instructions to cause a computing device to:
install a first container application on a first hardware platform, the first container application embedding a first web browser associated with the first hardware platform, the first container application embedding a first web server associated with the first hardware platform, the first container application converting a plurality of standard web browser controls to appear as first native application controls associated with the first hardware platform;
install a second different container application on a second different hardware platform, the second container application embedding a second web browser associated with the second hardware platform, the second container application embedding a second web server associated with the second hardware platform, the second container application converting the plurality of standard web browser controls to appear as second different native application controls associated with the second hardware platform;
deploy a web application to both the first container application on the first hardware platform and the second container application on the second hardware platform;
execute the web application via the first container application to produce a first display that appears native to the first hardware platform; and
execute the web application via the second container application to produce a second different display that appears native to the second hardware platform.

12. The computer readable memory device of claim 11, wherein installing the first container application on the first hardware platform includes installing the first container application via a download form a global network.

13. The computer readable memory device of claim 11, wherein deploying the web application to the first container application on the first hardware platform includes deploying the web application via a download form a global network.

14. The computer readable memory device of claim 11, wherein installing the first container application and deploying the web application include transmitting a build system that bundles the container application with the web application in a package that appears native to the final platform.

15. The computer readable memory device of claim 11, wherein the first container application provides controls that allow access to hardware devices on the first hardware platform.
